(19) United States
(12) Patent Application Publication
(10) Pub. No.: US 2006/0262862 A1
(43) Pub. Date: Nov. 23, 2006

(54) Deblocking filtering method used on video encoding/decoding and apparatus thereof

(76) Inventors: Chao-chung Cheng, Hsinchu (TW); Tian-sheuan Chang, Hsinchu (TW); Tien-hung Lin, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/404,339

(22) Filed: Apr. 13, 2006

(30) Foreign Application Priority Data
May 19, 2005 (TW) 94116275

(51) Int. Cl. H04N 11/04; H04N 7/12; H04B 1/66; H04N 11/02

(52) U.S. Cl. 375/240.24

(57) ABSTRACT

A deblocking filtering method used on video encoding/decoding includes: sequentially reading the subblocks adjacent to a vertical edge according to a deblocking direction, and performing a deblocking process on the vertical edge; performing a transposition on the pixel data of a current subblock; performing the deblocking process on a parallel edge of the current subblock, and outputting the pixel data of another subblock adjacent to the parallel edge after transposition; sequentially storing a plurality of current subblocks; transposing and outputting the pixel data of the plurality of current subblocks after completion of the deblocking of the current macroblock.

### BACKGROUND OF THE INVENTION

a) Field of the Invention

The invention relates to a deblocking filtering method used on video encoding/decoding and an apparatus thereof. More particularly, the invention relates to a deblocking filtering method and an apparatus thereof that can carry out a deblocking process via relatively smaller temporary storage space.

b) Description of the Related Art

Due to the fast advancement of information technology, lots of sounds and images can be stored and played in digital format, and therefore applications of audio/video information are greatly expanded. However, if the audio/video information is to be stored without any beforehand processing, an extremely large storage space would be needed to fully store the unprocessed information, especially the video information which records images; it would disadvantage the subsequent storage and transmission of the video/audio files. There have been many video-encoding technologies developed to solve the problem of over-sized video files; these technologies are able to effectively compress the video files while maintaining the original frame quality during playback, or at least maintaining the distortion level of frame quality within an acceptable range during playback.

Block-based video encoding methods have been widely applied in many video standards, such as that of Motion Picture Experts Group level 1 (MPEG-1), MPEG-2, MPEG-4, and H.26xx series. The video encoding standard H.264/AVC (MPEG-4 Part 10 Advanced Video Coding) made by ITU-T and ISO/IEC is used as an example to illustrate encoding methods that encode on single video frame basis. H.264/AVC video encoding method divides a video frame into a plurality of macroblocks of 16×16 pixels, wherein each macroblock is further divided into 4×4 subblocks. As shown in FIG. 1, a macroblock 1 segmented by bold lines is composed of subblocks a to p, and each subblock is of 4×4 pixels. The pixel of each subblock is then predicted and the predicted value replaces the original value as the pixel value of the subblock to reduce data quantity. Since the pixel values of the subblocks in an encoded video frame are not their original pixel values, the pixel values of subblocks have a great difference thereinbetween after the video frame has been decoded, and thereby the video frames cannot be presented naturally.

To reduce the aforementioned situation, decoded video frames must undergo a deblocking process to lower the differences between the pixel values of subblock edges. Referring to FIG. 2, the deblocking process must refer to the pixel values of pixels P1 to P4 in subblock a and the pixel values of pixels P5 to P8 in subblock b to adjust the pixel values of pixels P4 and P5, thereby lowering the difference thereinbetween, so that the edge Eab between subblocks a and b are unnoticeable. Therefore, the pixel values of all pixels in subblocks a and b must be referred to for carrying out the deblocking process on edge Eab.

Conventional technologies use one macroblock as a unit to carry out deblocking processes on edges between subblocks. Referring to FIG. 3A, the luminance data is represented by 4×4 subblocks, and the deblocking process starts with edges in the vertical direction: Lv1, Lv2, Lv3, and Lv4, and then continues with edges in the horizontal direction: Lh1, Lh2, Lh3, and Lh4. While processing the edges in the horizontal direction, data of the subblock can be transposed first so that the deblocking process can be proceeded with the same deblocking filter. Referring to FIG. 3B, the chrominance data is represented by 2×2 subblocks, and the deblocking process also starts with edges in the vertical direction, Cv1, Cv2, and then continues with edges in the horizontal direction, Ch1 and Ch2, after the data is transposed. It is to be noted that the right edge and bottom edge of the macroblock are not deblocked at this time but would be processed when adjacent macroblocks process the left edge and top edge thereof.

Take the luminance data as an example; in order to process all the edges of subblocks in a macroblock according to the abovementioned deblocking process, the pixel data of the entire macroblock has to be temporarily stored. Moreover, to process the top edge and right edge of the macroblock, pixel data of subblocks A, B, C, D, E, F, G, and H of adjacent macroblocks are required for referring, and thus the cost cannot be effectively lowered due to that the deblocking filtering apparatus must be equipped with sufficient storage space to temporarily store the needed reference data. Furthermore, a considerably large data transmission bandwidth is consumed for loading and outputting the relatively large reference data.

Concluding from above, how to perform a deblocking process with relatively smaller temporary storage space is the goal to achieve.

### SUMMARY OF THE INVENTION

In view of the above problems, an object of the invention is to provide a deblocking filtering method used on video encoding/decoding and an apparatus thereof, wherein the deblocking process can be performed with relatively smaller temporary storage space.

The deblocking filtering method of the invention is used on video encoding/decoding that divides a video frame into a plurality of macroblocks, in which each of the macroblocks is divided into M×M subblocks, and each subblock is of N×N pixels. The deblocking filtering method is used to perform a deblocking process on edges of the subblocks in a current macroblock.

The deblocking filtering method includes: sequentially reading the subblocks adjacent to a vertical edge according to a deblocking direction and performing a deblocking process on the vertical edge; performing a transposition on the pixel data of a current subblock; performing the deblocking process on a parallel edge of the current subblock, and transposing and outputting the pixel data of another subblock adjacent to the parallel edge; sequentially storing an M number of current subblocks; repeating the above steps, and transposing and outputting the pixel data of the M number of current subblocks after the deblocking process of the current macroblock is completed.

The deblocking filtering apparatus used on video encoding/decoding of the invention is for implementing the aforementioned deblocking filtering method. The deblocking filtering apparatus includes: a first storage element, a transposing storage element, a second storage element, a deblocking filter, a first multiplexer, a second multiplexer, a third multiplexer, and a fourth multiplexer. The first storage element is for storing the pixel data of a subblock. The transposing storage element is for transposing and storing the pixel data of the subblock. The second storage element is for storing the pixel data of transposed subblocks. The deblocking filter is for performing a deblocking process on an edge bordered by two subblocks.

The first multiplexer includes two input ends and one output end, wherein one of the input ends receives the pixel data of a subblock and the other input end is connected to the second storage element while the output end is connected to the deblocking filter; the first multiplexer can selectively output the pixel data received from the two input ends. The second multiplexer includes two input ends and one output end, wherein the two input ends are respectively connected to the first storage element and the transposing storage element while the output end is connected to the deblocking filter; the second multiplexer can selectively output the pixel data received from the two input ends. The third multiplexer includes two input ends both connected to the deblocking filter and one output end connected to the transposing storage element. One of the input ends receives the pixel data of a transposed subblock and the other input end receives the pixel data of an untransposed subblock; the third multiplexer can selectively output the pixel data received from the two input ends. The fourth multiplexer includes two input ends and one output end, wherein the two input ends are respectively connected to the deblocking filter and the transposing storage element; the fourth multiplexer can selectively output the pixel data of a deblocked subblock.

The deblocking filtering method used on video encoding/decoding and the apparatus thereof according to the invention are able to complete the deblocking process of the edges of the entire macroblock using relatively small storage space; thus the cost is reduced with reduced usage of memory and less data transmission bandwidth is consumed.

### BRIEF DESCRIPTION OF THE DRAWINGS

FIG. 1 is a schematic diagram illustrating subblocks required in a macroblock for performing a deblocking process.

FIG. 2 is a schematic diagram of a deblocking process.

FIG. 3A is a schematic diagram illustrating conventional deblocking process of the luminance data of a macroblock.

FIG. 3B is a schematic diagram illustrating convention deblocking process of the chrominance data of a macroblock.

FIG. 4 is a flow chart of a deblocking filtering method used on video encoding/decoding according to a preferred embodiment of the invention.

FIG. 5A is a schematic diagram of the invention performing a deblocking process on the luminance data of a macroblock.

FIG. 5B is a schematic diagram of the invention performing a deblocking process on the chrominance data of a macroblock.

FIG. 6 is a block diagram illustrating a deblocking filtering apparatus used on video encoding/decoding according to a preferred embodiment of the invention.

FIGS. 7A, 7B, and 7C are schematic diagrams of the invention performing a deblocking process on three specific types of edges in a macroblock.

### DETAILED DESCRIPTION OF THE INVENTION

The deblocking filtering method used on video encoding/decoding and the apparatus thereof according to a preferred embodiment of the invention will be described below with reference to the drawings, wherein the like reference numerals denote the like components.

A deblocking filtering method according to a preferred embodiment of the invention is used on video encoding/decoding that encodes/decodes a video data stream, wherein the video data includes a plurality of video frames each is divided into a plurality of macroblocks, and each macroblock is divided into M×M subblocks, each of which is composed of N×N pixels; M and N are positive integers. The deblocking filtering method of the invention takes one macroblock as one unit, and performs a deblocking process on the edges of each subblock in the macroblock. From hereinafter, the macroblock undergoing the deblocking process is referred to as a current macroblock and the subblock undergoing the deblocking process is referred to as a current subblock.

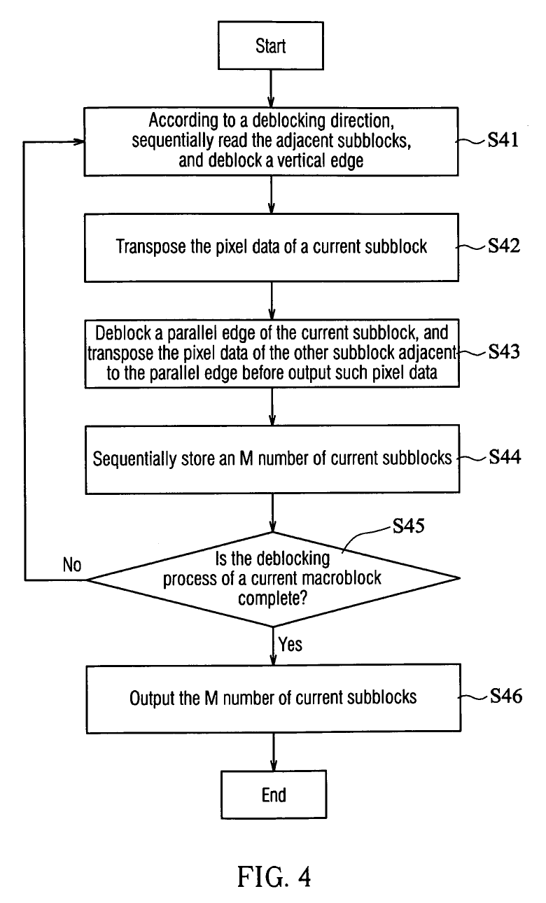

FIG. 4 is referred to for the description of the deblocking filtering method according to a preferred embodiment of the invention. First, the subblocks adjacent to a vertical edge are read sequentially according to a deblocking direction, and a deblocking process is performed on the vertical edge (S41), wherein the vertical edge refers to edges of the current subblock that are perpendicular to the deblocking direction. After the two vertical edges of the current subblock are processed, the pixel data thereof are transposed (S42), wherein the right edge and bottom edge of the current macroblock are not processed simultaneously with other edges of the current macroblock. Thus, a current subblock that contains part of the right edge or bottom edge of a current macroblock perpendicular to a deblocking direction only processes one vertical edge before a transposition is performed on the pixel data. Next, the deblocking process is performed on a parallel edge of the current subblock and the pixel data of the other subblock adjacent to the parallel edge is transposed and output (S43), wherein the parallel edge is parallel to the deblocking direction and is near the top edge or left edge of the current macroblock. The current subblock is stored after the two vertical edges and one parallel edge of the current subblock have been deblocked (S44), and when this subblock is needed, the fourth edge can undergo the deblocking process; the quantity of subblocks stored is the width of one macroblock, M. Step 45 (S45) is to determine if the deblocking process of the current macroblock is complete. If the deblocking process is not complete, then the abovementioned steps are repeated to process the subblocks of the current macroblock one by one; if the deblocking process is complete, the pixel data of the M number of subblocks stored are transposed and output (S46).

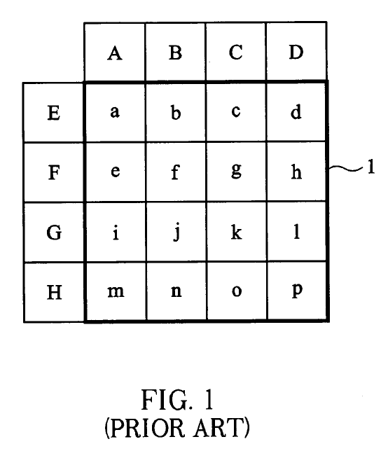

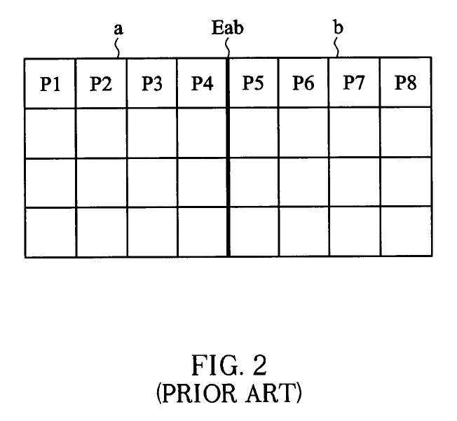

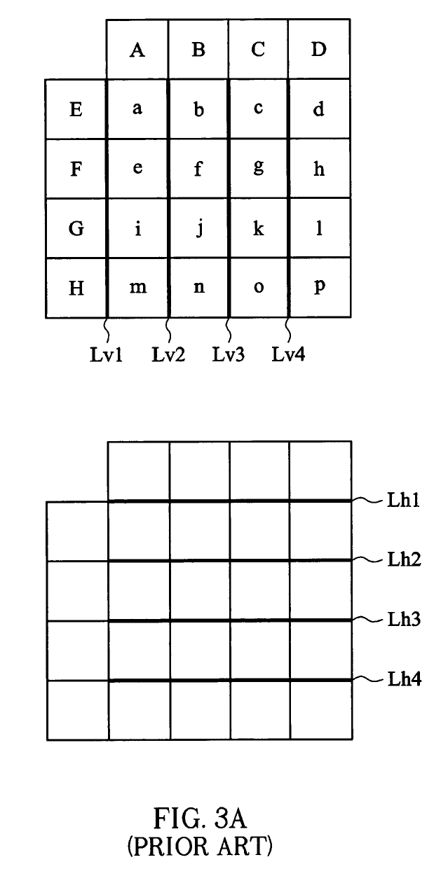

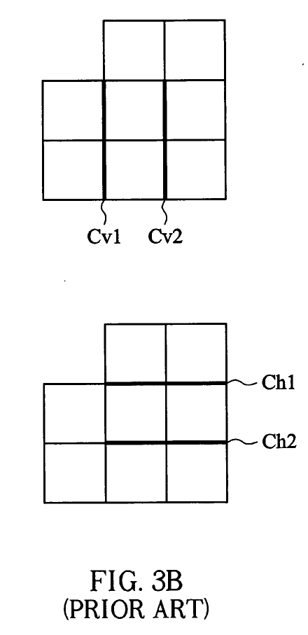

The video encoding standard of H.264/AVC is used as an example to illustrate the flow of the deblocking filtering method according to a preferred embodiment of the invention. H.264/AVC defines 16×16 pixels as one macroblock and 4×4 pixels as one subblock; thereby a macroblock includes 4×4 subblocks. Referring to FIG. SA, the luminance data of a macroblock is represented by 4×4 subblocks (area outlined by bold lines in the figure), in which edges labeled L0 to L31 need to be deblocked. The order of edges for processing is as represented by the numbers if a deblocking direction of left to right and top to bottom is used. For example, subblock E and subblock a (same reference number as FIG. 1) are loaded for processing edge L0, and afterwards, subblock E is output and subblock b is then loaded for processing edge L1. After edges L0 and L1 (vertical edges) of subblock a have been processed, the pixel data of subblock a is transposed and edge L2 (parallel edge) is processed. Subblocks A, B, C, and D can be loaded in advance and the pixel data can be stored after transposition so that they can readily be applied when processing edges L2, L4, L6, and L7. Edges L0, L1, and L2 of subblock a are stored after they have been processed and can be applied when processing edge L10, and subblock A is output after the pixel data is transposed back.

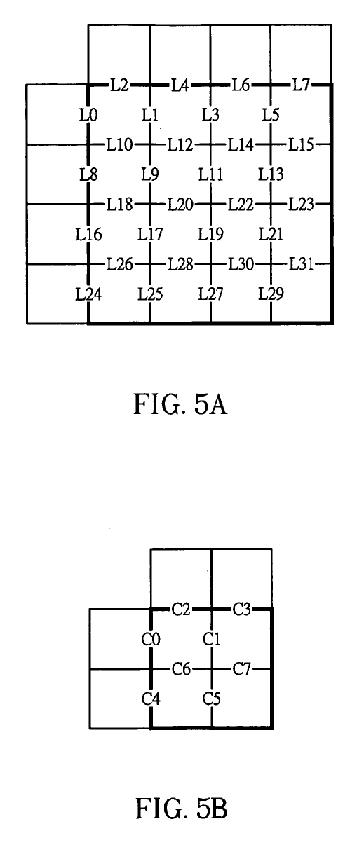

Next, subblock c is loaded to process edge L3. The pixel data is then transposed to process edge L4, and subblock b is stored for application after subblock B is output. The relative steps are repeated until all of the edges are processed, and at last, subblocks m, n, o, and p are output for performing the deblocking process on the next macroblock. It is to be noted that the right edge and bottom edge of the macroblock did not undergo the deblocking process; rather, they are processed when the left edge and top edge of adjacent macroblocks are processed. Therefore, subblocks containing edges that are part of the right edge or bottom edge of the macroblock perpendicular to the deblocking direction can proceed directly to process the parallel edge. For example, if the deblocking direction is horizontal, the right edge of the macroblock is perpendicular to the deblocking direction, and thus the right edges of subblocks d, h, l, and p in FIG. 5A are not processed, rather, the top edges L7, L15, L23, and L31 are processed directly.

The chrominance data represented by 2×2 subblocks are processed by the deblocking process in the same sequence. As shown in FIG. 5B, the processing sequence is: left edge, right edge, and top edge of the subblocks, if the deblocking direction is left to right and top to bottom, which means edges C0 to C7 are processed in numerical order.

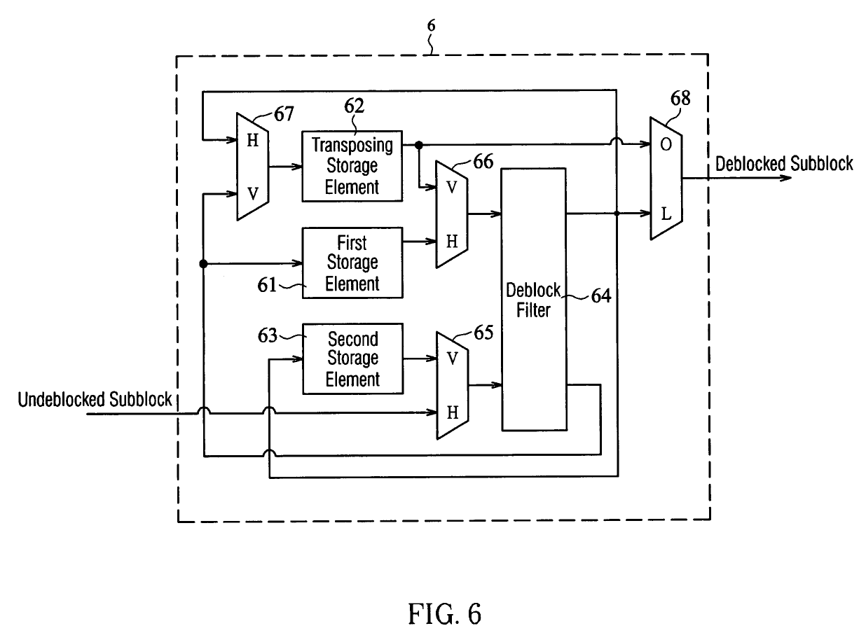

Referring to FIG. 6, a deblocking filtering apparatus 6 used on video encoding/decoding according to a preferred embodiment of the invention includes: a first storage element 61, a transposing storage element 62, a second storage element 63, a deblocking filter 64, a first multiplexer 65, a second multiplexer 66, a third multiplexer 67, and a fourth multiplexer 68. The first storage element 61 is used to store the pixel data of a subblock for processing the edges of that subblock. The first storage element 61 can be a shift register that can store the pixel data of one subblock, N×N×8 bits. The transposing storage element 62 is used to transpose and store the pixel data of a subblock and can be a transposition register that also can store the pixel data of one subblock, N×N×8 bits. The second storage element 63 is used to store the pixel data of subblocks that have been transposed, and the second storage element 63 can store one macroblock width of subblocks, M×N×N×8 bits; take the example from above, the storage space is 4×4×4×8 bits. The second storage element 63 can be a memory, like SDRAM, and preferably has two transmit ends for reading and writing data at the same time. The deblocking filter 64 can, according to the pixel data of any two subblocks, carry out a deblocking process on an edge bordered by the two subblocks.

The first multiplexer 65 includes two input ends and one output end, wherein one of the input ends receives the pixel data of an undeblocked subblock (UDS) that has been loaded and the other input end is connected to the second storage element 63 while the output end is connected to the deblocking filter 64. The first multiplexer 65 can selectively output the pixel data received from the two input ends. The second multiplexer 66 includes two input ends and one output end, wherein one of the input ends is connected to the first storage element 61 and the other input end is connected to the transposing storage element 62 while the output end is connected to the deblocking filter 64. The second multiplexer 66 can selectively output the pixel data received from the two input ends. The third multiplexer 67 includes two input ends and one output end, wherein both of the input ends are connected to the deblocking filter 64 and the output end is connected to the transposing storage element 62. One of the two input ends receives the pixel data of a subblock that has been transposed and the other input end receives the pixel data of a subblock that has not been transposed. The third multiplexer 67 can selectively output the pixel data received from the two input ends. The fourth multiplexer 68 includes two input ends and one output end, wherein one of the input ends is connected to the deblocking filter 64, and the other input end is connected to the transposing storage element 62. The fourth multiplexer 68 can selectively output the pixel data of a deblocked subblock (DS).

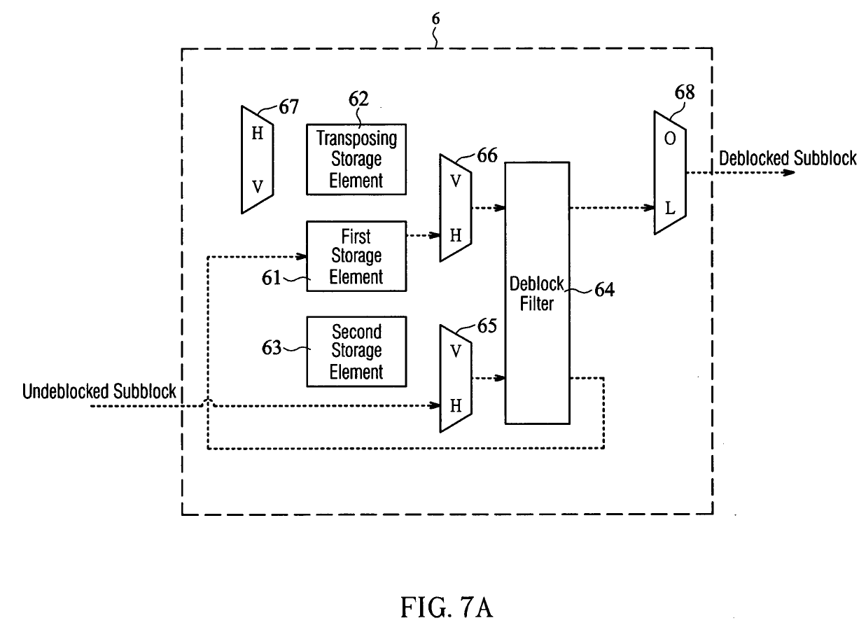

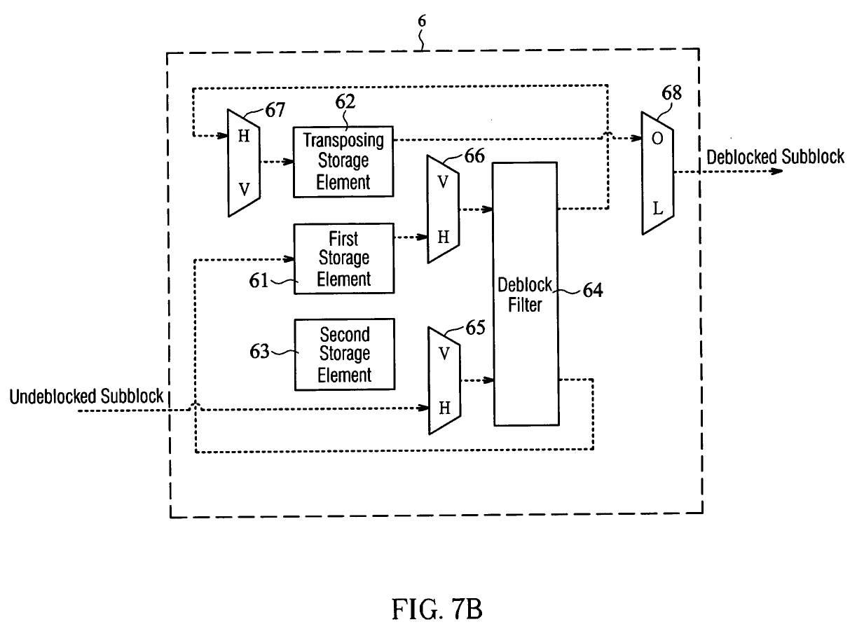

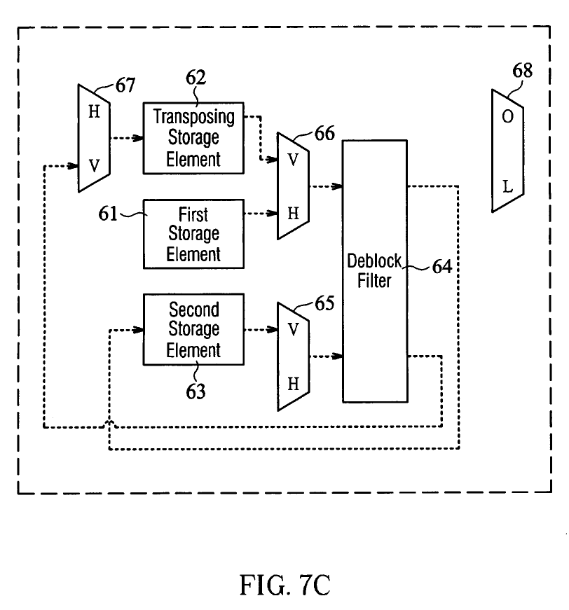

Referring to FIGS. 7A to 7C, the processing of pixel data in the deblocking filtering apparatus 6 of the invention during the deblocking process is illustrated, wherein the dotted lines with arrows represent the moving directions of the pixel data in the deblocking filtering apparatus 6. Referring to FIG. 7A, the deblocking process of edges L0, L8, L16, and L24 is illustrated; take the processing of edge L0 as an example. First, the deblocking filtering apparatus 6 loads subblock E and stores it in the first storage element 61 before loading subblock a. Subblock E and subblock a are respectively transmitted via the second multiplexer 66 and the first multiplexer 65 to the deblocking filter 64 for the deblocking process. After edge L0 has been processed, subblock a is stored in the first storage element 61 for processing edge L1, and subblock E is directly output.

FIG. 7B illustrates the deblocking process of other vertical edges; take the processing of edge L1 as an example. Subblock b is loaded, and with subblock a stored in the first storage element 61, the deblocking process is proceeded. After L1 has been processed, the pixel data of subblock a is transposed and stored in the transposing storage element 62 for processing edge L2, and the subblock that was stored in the transposing storage element 62 can be directly output. Subblock b is then stored in the first storage element 61 for processing edge L3.

FIG. 7C illustrates the deblocking process of parallel edges; take the processing of edge L2 as an example. Transposed subblocks A, B, C, and D are stored in the second storage element 63 in advance, thereby subblock A in the second storage element 63 and subblock a in the transposing storage element 62 are transmitted to the deblocking filter 64 for the deblocking process. After the deblocking process, subblock a is stored in the second storage element 63 waiting to process edge L10; the second storage element 63 now stores therein subblocks a, B, C, and D. Subblock A is then sent to be transposed again and stored in the transposing storage element 62, and when the next subblock is transmitted to the transposing storage element 62, subblock A will be output.

With respect to the video encoding standard of H.264/AVC, the deblocking filtering method used on video encoding/decoding and the apparatus thereof according to the invention only require a storage space of six subblocks to complete the processing of edges in an entire macroblock; thus, the cost is reduced due to reduction in memory usage. Moreover, according to the deblocking filtering method and apparatus of the invention, loading subblocks and performing the deblocking process are proceeded simultaneously during most parts of the process, thereby the deblocking efficiency is enhanced and the consumption of data transmission bandwidth is reduced.

While the invention has been described by way of example and in terms of the preferred embodiment, it is to be understood that the invention is not limited to the disclosed embodiments. In other words, it is intended to include equivalent modifications and changes of the above embodiments without departing from the spirit and scope of the invention as would be apparent to those skilled in the art. For example, the deblocking direction used in aforementioned illustrations is from left to right and then top to bottom, but those skilled in the art can also realize the invention by changing the deblocking direction, such as from top to bottom and then left to right. Moreover, the sizes of the subblocks and the macroblock can be varied according to demands, for example, M can be 2 or 8, and N can be 2, 8, or 16. Therefore, the scope of the appended claims should be accorded the broadest interpretation so as to encompass all such equivalent modifications and changes.

What is claimed is:

1. A deblocking filtering method, which is used on video encoding/decoding that encodes/decodes a video data stream, the video data including a plurality of video frames, each video frame being divided into a plurality of macroblocks, each macroblock being divided into M×M subblocks, and each subblock being composed of N×N pixels, wherein M and N are positive integers and M≧2 and N≧2, the deblocking filtering method being used to perform a deblocking process on edges of the subblocks in a current macroblock, the deblocking filtering method comprising:
sequentially reading the subblocks adjacent to a vertical edge according to a deblocking direction and performing a deblocking process on the vertical edge, the vertical edge being perpendicular to the deblock direction;
transposing the pixel data of a current subblock, the current subblock being the subblock with the vertical edge being processed by the deblocking process, wherein the vertical edge is not part of the right edge or bottom edge of the current macroblock perpendicular to the deblocking direction;
performing the deblocking process on a parallel edge of the current subblock and transposing and outputting the pixel data of another subblock adjacent to the parallel edge, the parallel edge being parallel to the deblocking direction and near the top edge or left edge of the current macroblock;
sequentially storing an M number of current subblocks; and
repeating the aforementioned steps, and transposing and outputting the pixel data of the M number of current subblocks after the completion of the deblocking of the current macroblock.

2. The deblocking filtering method as described in claim 1, further comprising:
reading and storing the M number of adjacent subblocks, the adjacent subblocks being adjacent to the top edge or left edge of the current macroblock parallel to the deblocking direction.

3. The deblocking filtering method as described in claim 1, wherein the deblocking direction is from left to right, and top to bottom.

4. The deblocking filtering method as described in claim 1, wherein the deblocking direction is from top to bottom and left to right.

5. The deblocking filtering method as described in claim 1, wherein N is 2, 4, 8, or 16.

6. The deblocking filtering method as described in claim 1, wherein M is 2, 4, or 8.

7. The deblocking filtering method as described in claim 1, wherein the video encoding/decoding conforms to the video encoding standard of H.264/AVC.

8. A deblocking filtering apparatus, which is used in a video encoding/decoding system that encodes/decodes a video data stream, the video data including a plurality of video frames, each video frame being divided into a plurality of macroblocks, each macroblock being divided into M×M subblocks, and each subblock being composed of N×N pixels, wherein M and N are positive integers and M≧2 and N≧2, the deblocking filtering apparatus comprising:
a first storage element for storing the pixel data of a subblock;
a transposing storage element for transposing and storing the pixel data of the subblock;
a second storage element for storing the pixel data of transposed subblocks;
a deblocking filter for performing a deblocking process on an edge bordered by two subblocks;
a first multiplexer having two input ends and one output end, wherein one of the input ends receives the pixel data of the subblock and the other input end is connected to the second storage element while the output end is connected to the deblocking filter, the first multiplexer being able to selectively output the pixel data received from the two input ends;
a second multiplexer having two input ends and one output end, the two input ends being respectively connected to the first storage element and the transposing storage element, the output end being connected to the deblocking filter, the second multiplexer being able to selectively output the pixel data received from the two input ends;
a third multiplexer having two input ends both connected to the deblocking filter and one output end connected to the transposing storage element, wherein one of the input ends receives the pixel data of a transposed subblock and the other input end receives the pixel data of an untransposed subblock, the third multiplexer being able to selectively output the pixel data received from the two input ends; and
a fourth multiplexer having two input ends and one output end, the two input ends being respectively connected to the deblocking filter and the transposing storage element, wherein the fourth multiplexer can selectively output the pixel data of a deblocked subblock.

9. The deblocking filtering apparatus as described in claim 8, wherein the first storage element is a shift register.

10. The deblocking filtering apparatus as described in claim 9, wherein the storage space of the shift register is N×N×8 bits.

11. The deblocking filtering apparatus as described in claim 8, wherein the transposing storage element is a transposition register.

12. The deblocking filtering apparatus as described in claim 11, wherein the storage space of the transposition register is N×N×8 bits.

13. The deblocking filtering apparatus as described in claim 8, wherein the second storage element is a memory.

14. The deblocking filtering apparatus as described in claim 13, wherein the storage space of the memory is M×N×N×8 bits.

15. The deblocking filtering apparatus as described in claim 13, wherein the memory includes two transmit ends for reading and writing data simultaneously.

16. The deblocking filtering apparatus as described in claim 13, wherein the memory is an SDRAM.

17. The deblocking filtering apparatus as described in claim 8, wherein N is 2, 4, 8, or

18. The deblocking filtering apparatus as described in claim 8, wherein M is 2, 4, or 8.

19. The deblocking filtering apparatus as described in claim 8, wherein the video encoding/decoding system conforms to the video encoding standard of H.264/AVC.
